(19) United States
(12) Patent Application Publication
(10) Pub. No.: US 2026/0257249 A1
(43) Pub. Date: Sep. 3, 2026

(54) HIGH-PRESSURE WASHER

(71) Applicants: Jung Mo KIM, Busan (KR); KT&G CORPORATION, Daejeon (KR)

(72) Inventors: Jung Mo KIM, Busan (KR); Jae Seok LEE, Daejeon (KR)

(73) Assignees: Jung Mo KIM, Busan (KR); KT&G CORPORATION, Daejeon (KR)

(21) Appl. No.: 18/835,172

(22) PCT Filed: Mar. 30, 2023
(86) PCT No.: PCT/KR2023/004251

§ 371 Date: Aug. 1, 2024

(30) Foreign Application Priority Data
Mar. 24, 2023 (KR) 10-2023-0038682

(51) Int. Cl. B08B 3/02; B05B 13/06; B05B 15/40; B08B 3/14

(52) U.S. Cl. CPC B08B 3/02; B05B 13/0645; B05B 15/40; B08B 3/14

(57) ABSTRACT

A high-pressure washer includes a main body, a cover configured to cover an upper portion of the main body, a washing tank formed between the main body and the cover, a washing assembly disposed in the washing tank, wherein the washing assembly may include a washing module configured to clean a washing object, and wherein the washing module may include a first washing element disposed outside the washing object and configured to spray washing water and a second washing element disposed in the washing object and configured to spray washing water.

### TECHNICAL FIELD

The following embodiments relate to a high-pressure washer.

### BACKGROUND ART

In general, cigarette machines, packaging machines, and low ignition propensity (LIP) coating units, which frequently use adhesives in industrial settings, utilize the adhesive supply nozzles of the adhesive application device to supply glue-type adhesives, thereby adhesively packaging objects to be packaged. Drums used for storing adhesives in adhesive application devices are prone to contamination due to various substances scattering during the production process, so the drums need to be cleaned at regular intervals. In particular, because adhesives have strong adhesive properties and solidifies over time, simply impregnating a drum in cleaning water is not enough to keep the drum clean. Therefore, cleaning requires using powerful cleaning water.

Conventionally, the adhesive stuck to a drum is softened by continuously supplying hot water, and then the packaging machine is cleaned manually by workers. This method results in high consumption of cleaning water, requires a lot of cleaning time, and leads to significant energy waste due to the use of gas for heating the water.

### DISCLOSURE OF THE INVENTION

### Technical Goals

An embodiment provides a high-pressure washer that reduces contamination and other issues caused by solidified adhesives by cleaning parts to which adhesive materials are applied at regular intervals.

An embodiment provides a high-pressure washer that filters cleaning water sucked from a water tank in a filtration device and then circulates it as cleaning water, thereby reducing the waste of the cleaning water by allowing the water in the water tank to be used repeatedly.

### Technical Solutions

A high-pressure washer according to various embodiments includes a main body, a cover configured to cover an upper portion of the main body, a washing tank formed between the main body and the cover, a washing assembly disposed in the washing tank, wherein the washing assembly includes a washing module configured to clean a washing object, and wherein the washing module includes a first washing element disposed outside the washing object and configured to spray washing water and a second washing element disposed in the washing object and configured to spray washing water.

In an embodiment, the washing assembly may further include a rotating module configured to rotate the washing object.

In an embodiment, the high-pressure washer may further include a jig configured to fix the washing object to the rotating module.

In an embodiment, the first washing element and the second washing element may include a spray stem extending upward in the washing tank and through which washing water moves, a spray branch extending outward from the spray stem, and a spray nozzle disposed at an end of the spray branch.

In an embodiment, the spray branch may extend in a direction traversing a longitudinal direction of the spray stem, and the spray nozzle may face the washing object.

In an embodiment, the high-pressure washer may further include a water storage tank formed on a bottom of the washing tank, wherein washing water that washes the washing object may be returned to the water storage tank, filtered, and reused.

In an embodiment, the washing assembly may further include a rotating module configured to rotate the washing object, the rotating module may be rotated by a motor disposed to be spaced apart from the washing tank and the water storage tank, and the motor may be connected to the rotating module by a power transmission unit.

In an embodiment, the high-pressure washer may further include a water cleaning module disposed in the water storage tank, wherein the water cleaning module may include a suction port formed at a height corresponding to a water surface level of the washing water stored in the water storage tank and a discharge port configured to discharge floating matter introduced into the suction port to outside.

In an embodiment, the high-pressure washer may further include a circulation port in fluid communication with the water storage tank, wherein the circulation port may be configured to transport the washing water returned to the water storage tank to a filter device.

In an embodiment, the high-pressure washer may further include a heater disposed in the water storage tank and configured to heat the washing water.

In an embodiment, two or more of the washing assemblies may be disposed in the washing tank.

In an embodiment, the second washing element may be disposed on a central upper portion of the rotating module.

A high-pressure washer according to various embodiments includes a main body, a cover configured to cover the main body, a washing tank formed between the main body and the cover, and a washing assembly disposed in the washing tank, wherein the washing assembly may include a rotating module configured to rotate a washing object, and a washing module configured to clean the washing object, and wherein the washing module may include a first washing element disposed to be spaced apart from the rotating module and a second washing element disposed at a center of the rotating module.

In an embodiment, the first washing element may include a first nozzle facing an outer portion of the washing object, and the second washing element may include a second nozzle disposed to face an inner portion of the washing object.

### Effects of the Invention

A high-pressure washer according to an embodiment may reduce contamination and other issues caused by solidified adhesives by cleaning parts to which adhesive materials are applied at regular intervals.

The high-pressure washer according to an embodiment may filter cleaning water sucked from a water tank in a filtration device and then circulate it as cleaning water, thereby reducing the waste of the cleaning water by allowing the water in the water tank to be used repeatedly.

The effects of the high-pressure washer according to an embodiment are not limited to the above-mentioned effects, and other unmentioned effects can be clearly understood from the above description by those having ordinary skill in the technical field to which the present disclosure pertains.

### BRIEF DESCRIPTION OF DRAWINGS

FIG. 1 is a schematic perspective view of a high-pressure washer according to an embodiment.

FIG. 2 is a schematic rear view of a high-pressure washer according to an embodiment.

FIG. 3 is a schematic cross-sectional view of a high-pressure washer according to an embodiment.

FIG. 4 is an enlarged view of a region X of the high-pressure washer illustrated in FIG. 3, according to an embodiment.

FIG. 5 is a schematic perspective view of a washing tank of a high-pressure washer, according to an embodiment.

### BEST MODE FOR CARRYING OUT THE INVENTION

The terms used to describe the embodiments are selected from among common terms that are currently widely used, in consideration of their function in the disclosure. However, different terms may be used depending on an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and which may be implemented as hardware, software, or a combination of hardware and software.

As used herein, an expression such as “at least one of” that precedes listed components modifies not each of the listed components but all the listed components. For example, the expression “at least one of a, b, and c” should be construed as including a, b, c, a and b, a and c, b and c, or a, b, and c.

In the following embodiments, the term “aerosol generating article” may refer to an article that accommodates a medium, in which an aerosol passes through the article and the medium is transferred. A representative example of the aerosol generating article may be a cigarette. However, the scope of the disclosure is not limited thereto.

In the following embodiments, “upward” or “upper” refers to a direction (e.g., +Z direction in the drawing) away from the bottom surface or a portion located in that direction, and “downward” or “lower” refers to a direction (e.g., −Z direction in the drawing) toward the bottom surface or a portion located in that direction. The terms “upper” and “lower” may be used to describe relative positions of components of a high-pressure washer.

An embodiment may be implemented in the form of a recording medium including instructions executable by a computer, such as a program module executable by the computer. A computer-readable medium may be any available medium that can be accessed by a computer and includes all of a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

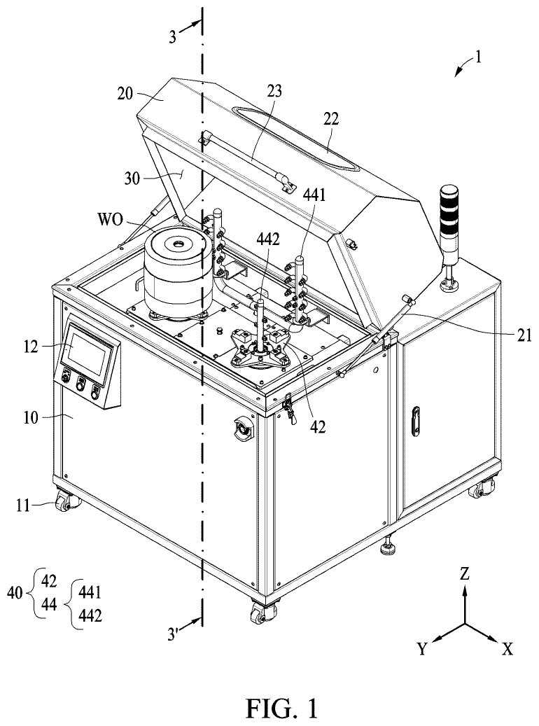

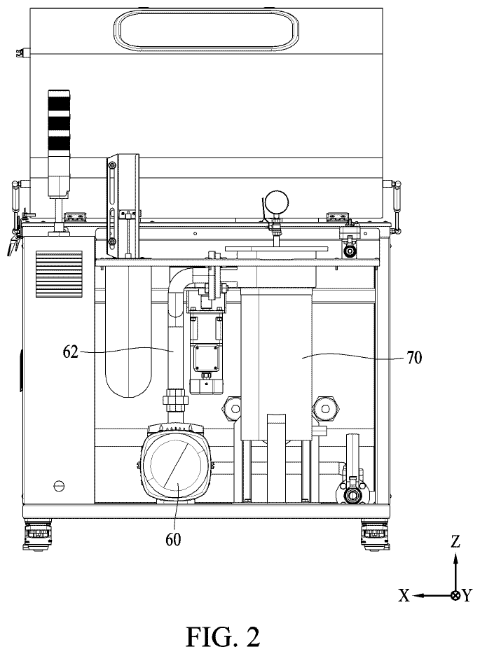

FIG. 1 is a schematic perspective view of a high-pressure washer 1, according to an embodiment. FIG. 2 is a schematic rear view of the high-pressure washer 1 according to an embodiment.

Referring to FIGS. 1 and 2, the high-pressure washer 1 may include a main body 10, a cover 20, a washing tank 30, a washing assembly 40, a pump 60, and a filter device 70.

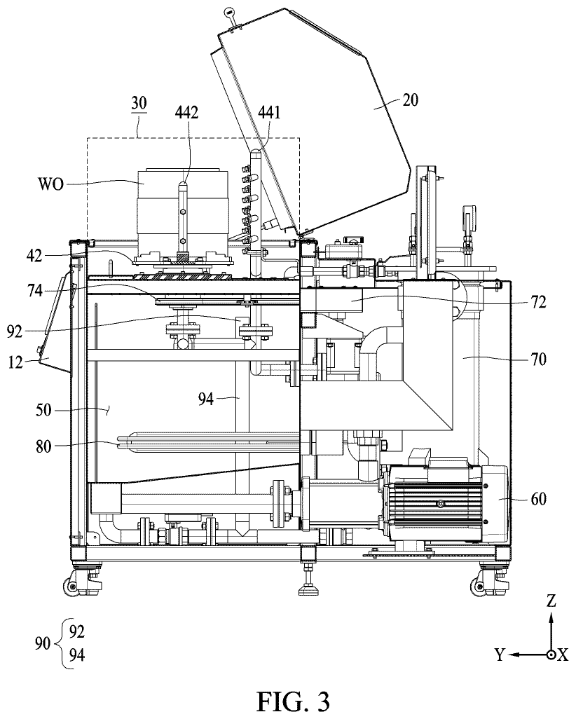

In an embodiment, the main body 10 may be formed of a sturdy material to protect some components included in the high-pressure washer 1. The main body 10 according to an embodiment may be formed in a hexahedral shape. The main body 10 may include a water storage tank (e.g., a water storage tank 50 of FIG. 3). The main body 10 according to an embodiment may include a wheel 11 on the bottom. The wheel 11 may facilitate the movement of the heavy high-pressure washer 1. The main body 10 according to an embodiment may include a screen 12. The screen 12 may display the operational status and monitoring control alarms of the high-pressure washer 1, such as washing water pressure, washing water temperature, filter pressure, washing time, water level control, and the number of washing water replacements. The screen 12 may include a touch panel, so a user may control the operational status through the touch panel.

In an embodiment, the cover 20 may be disposed to cover the upper portion of the main body 10. The cover 20 may be hinged to the upper portion of the main body 10 and may be open and closed. A side surface of the cover 20 may be connected to the main body 10 by a hydraulic or pneumatic cylinder 21. In an embodiment, the cover 20 may further include a window 22. The window 22 may be formed of a transparent material such as glass or acrylic. The user may easily check the washing situation of the interior of the washing tank 30 through the window 22. In an embodiment, the cover 20 may further include a handle 23. The user may easily open and close the cover 20 by holding the handle 23.

In an embodiment, the washing tank 30 may include a space formed between the main body 10 and the cover 20. The washing tank 30 is a space in which actual washing of a washing object (WO) occurs. In an embodiment, the WO may be a drum-shaped unit including a bottom and a side wall extending from the bottom to one side and forming a cavity. A washing assembly 40 may be disposed in the washing tank 30. Two or more washing assemblies 40 may be disposed in the washing tank 30. The washing tank 30 may further include a drainage hole (not shown) in the bottom surface of the washing tank 30. Washing water sprayed onto the WO by the washing assembly 40 may be returned to a water storage tank (e.g., the water storage tank 50 of FIG. 3) in the main body through the drainage hole.

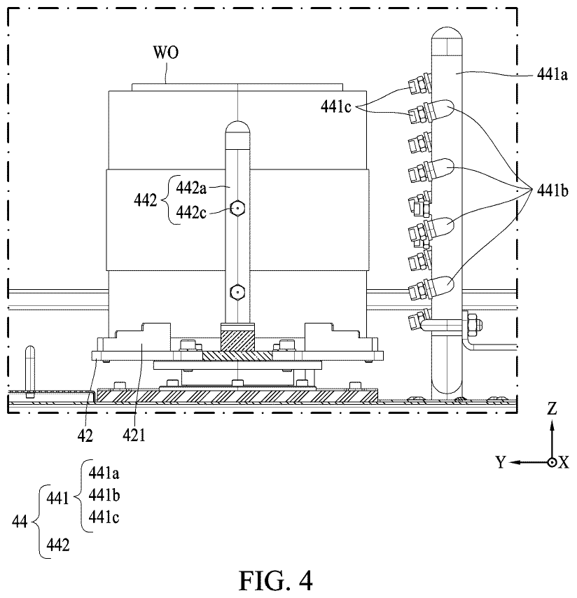

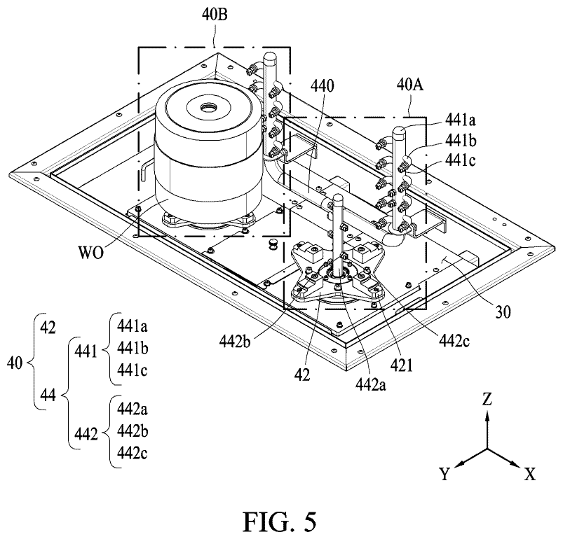

In an embodiment, the washing assembly 40 may include a rotating module 42 and a washing module 44. The rotating module 42 may be disposed on the bottom of the washing tank 30 and may rotate about an axis perpendicular to the bottom. The WO is coupled to the rotating module 42 and may rotate together with the rotating module 42. The washing module 44 may be formed to extend upward from the bottom surface of the washing tank 30. Washing water is sprayed from a nozzle included in the washing module 44 toward the WO to clean the WO. The washing module 44 may include a first washing element 441 and a second washing element 442. The first washing element 441 may be disposed to be spaced apart from the WO and may wash the outer surface of the WO. The second washing element 442 may be disposed in the WO and may wash the inner surface of the WO. The washing assembly 40 is described in detail below with reference to FIGS. 4 and 5.

In an embodiment, the pump 60 may suck washing water from the water storage tank (e.g., the water storage tank 50 of FIG. 3) through a circulation port 62 and transport the washing water to the filter device 70. The circulation port 62 may be in fluid communication with the water storage tank 50. The pump 60 may supply the washing water purified by the filter device 70 back to the washing assembly 40.

In an embodiment, the filter device 70 may filter washing water used to wash a WO (e.g., the WO of FIG. 1) in a washing tank (e.g., the washing tank 30 of FIG. 1). The washing water filtered by the filter device 70 may be sprayed back into the washing tank 30 through the washing assembly 40. The filter device 70 may include at least one filtering element, such as a filter screen, a sedimentation filter, an activated carbon filter, an osmotic pressure filter, and a high efficiency particulate air (HEPA) filter. The filtering element included in the filter device 70 according to an embodiment may be replaced after being used approximately 1,000 times.

In an embodiment, the washing water may be repeatedly reused while being circulated through the water storage tank 50 and the filter device 70 by the pump 60. In this case, the number of repeated uses of the washing water may be determined depending on the type and shape of a glue part. For example, when a drum-shaped WO 100 is washed, the washing water may be reused approximately 100 times.

FIG. 3 is a schematic cross-sectional view of the high-pressure washer 1 of FIG. 1 taken along line 3-3′, according to an embodiment. Referring to FIG. 3, the high-pressure washer 1 according to an embodiment may further include the water storage tank 50, a heater 80, and a water cleaning module 90.

In an embodiment, the water storage tank 50 may be formed on the bottom of the washing tank 30. The water storage tank 50 may store the washing water supplied to the washing module 44. The heater 80 may be disposed in the inner space of the water storage tank 50. The heater 80 may be an electrically operated heater. The heater 80 may heat washing water. The heater 80 may further include a temperature sensor (not shown), and the temperature sensor may detect the temperature of the washing water inside the water storage tank 50 to ensure a constant temperature is maintained. In an embodiment, the water storage tank 50 may be partitioned from other components (e.g., the pump 60, the filter device 70, and a motor 72) of the high-pressure washer 1. Since the water storage tank 50 is a space for storing washing water, it is desirable that electronic components sensitive to water or foreign substances are placed away from the water storage tank 50. In an embodiment, the washing water sprayed by the washing module 44 may wash the WO, and the contaminated washing water resulting from washing the WO may be returned to the water storage tank 50. The contaminated washing water in the water storage tank 50 may be moved to the filter device 70 and filtered.

In an embodiment, the motor 72 may generate driving force necessary to rotate the rotating module 42. The motor 72 may be spaced apart from the washing tank 30 and the water storage tank 50. Since the washing water and foreign substances washed by high-pressure washing water are dispersed in all directions, the motor 72 may be disposed to be spaced apart from the washing tank 30 and the water storage tank 50 to prevent the motor 72 from breaking down. In order to easily transfer the power of the motor 72 to the rotating module 42, the high-pressure washer 1 may further include a power transmission unit 74. The power transmission unit 74 is an element for transmitting the rotational force of the motor 72 to the rotating module 42 and may include a chain, a conveyor belt, a timing belt, a worm gear, a gear box, and the like. When the high-pressure washer 1 according to an embodiment includes two or more rotating modules 42 (e.g., the high-pressure washer of FIG. 5 includes two rotating modules 42), the power transmission unit 74 may be disposed to connect the motor 72 to all passive power transmission parts (not shown) formed at the bottom of the two or more rotating modules 42.

Continuously referring to FIG. 3, the water cleaning module 90 may be disposed in the water storage tank 50. The water cleaning module 90 may include a suction port 92 and a discharge port 94. The height of the suction port 92 may be disposed to correspond to the water surface level of the washing water stored in the water storage tank 50. As the washing water used to wash the WO falls from the washing tank 30 to the water storage tank 50 by gravity, waves may be formed on the surface of the washing water stored in the water storage tank 50. Due to the waves of the washing water, floating matters may overflow into the suction port 92 of the water cleaning module 90. The floating matters (e.g., glue product residue, foreign substances, etc.) introduced into the suction port 92 may move along the discharge port 94 connected to the suction port 92 and may be discharged to the outside of a high-pressure washer (e.g., the high-pressure washer 1 of FIG. 1). In an embodiment, the water cleaning module 90 may operate automatically at predetermined time intervals. In an embodiment, the water cleaning module 90 may operate only when the WO is not coupled to a jig 421 of the rotating module 42. The cycle, duration, and the like of the automatic operation of the water cleaning module 90 may be viewed and controlled through a screen (e.g., the screen 12 of FIG. 1) of the high-pressure washer (e.g., the high-pressure washer 1 of FIG. 1).

FIG. 4 is an enlarged view of the washing tank 30 according to the cross-sectional view of the high-pressure washer 1 illustrated in FIG. 3. FIG. 5 is a schematic perspective view of the washing tank 30 of the high-pressure washer 1, according to an embodiment.

Referring to FIGS. 4 and 5, the washing assembly 40 disposed in the washing tank 30 may include the rotating module 42 and the washing module 44. The washing assembly 40 may wash the WO. In an embodiment, the WO may be a drum-shaped unit including a bottom and a side wall extending from the bottom to one side and forming a cavity.

In an embodiment, the rotating module 42 may be disposed on the bottom surface of the washing tank 30 and may rotate around the axis perpendicular to the bottom surface. The WO is coupled to the rotating module 42 and may rotate together with the rotating module 42. The jig 421 may be disposed on the upper portion of the rotating module 42. The jig 421 may securely fix the WO to the rotating module 42 such that even when washing water with high spraying pressure is sprayed onto the WO from the washing module 44 the WO may rotate along with the rotating module 42. The jig 421 may fix the WO using an interference fit method, a coupling method, a magnetic coupling method, an electromagnetic coupling method, and the like, and commonly used fixing methods may be used. Two or more jigs 421 may be disposed on one rotating module 42. When two or more jigs 421 are included in one rotating module 42, the spacing between the jigs 421 may be constantly formed. For example, an angle formed between two adjacent jigs 421 may be constant surrounding the second washing element 442.

In an embodiment, the washing module 44 may include the first washing element 441 and the second washing element 442. The first washing element 441 may be disposed to be spaced apart from the rotating module 42 and may wash the outer surface of the WO. The second washing element 442 may be disposed to correspond to the rotation shaft of the rotating module 42. That is, the second washing element 442 may extend upward from the center of the rotating module 42. The inner surface of the WO may be washed.

In an embodiment, the first washing element 441 and the second washing element 442 may each include a spray stem 441a, 442a, a spray branch 441b, 442b, and a spray nozzle 441c, 442c. The spray stem 441a, 442a may be formed to extend upward from the bottom surface of the washing tank. The spray stem 441a, 442a may move washing water required for washing and transfer the washing water to the spray branch 441b, 442b. The spray branch 441b, 442b may be formed to extend outward from the spray stem 441a, 442a. The spray branch 441b, 442b may be formed to extend in the direction traversing the longitudinal direction of the spray stem 441a, 442a. Desirably, the spray branch 441b, 442b may be formed to be perpendicular to the longitudinal direction of the spray stem 441a, 442a. The spray branch 441b, 442b may not necessarily have to be formed in a straight line and may include a curved shape. A plurality of spray branches 441b and 442b may extend from one spray stem 441a, 442a. The plurality of spray branches 441b and 442b may be formed with the same or different lengths/shapes. The spray nozzle 441c, 442c may be disposed at an end of the spray branch 441b, 442b. The spray nozzle 441c, 442c may include a nozzle having a diameter much less than the inner diameter of the spray branch 441b, 442b, thereby enabling high-pressure spraying of washing water. As illustrated in FIG. 4, all spray nozzles 441c according to an embodiment may be disposed to face the WO. However, the plurality of spray nozzles 441c may not all spray washing water in parallel directions. The plurality of spray nozzles 441c may wash the outer surface of a wider range of the WO by having different spray angles, thus achieving improved washing efficiency.

In an embodiment, each spray nozzle 441c, 442c may spray washing water in the direction in which the spray nozzle 441c, 442c is arranged, and as the WO coupled to the rotating module 42 by the jig 421 rotates, washing of all surfaces of the WO may be achieved.

Continuously referring to FIG. 5, two or more washing assemblies 40 may be disposed in the washing tank 30. A first washing assembly 40A and a second washing assembly 40B may each include a rotating module 42 and a washing module 44 including the first washing element 441 and the second washing element 442. The rotating module 42 included in the first washing assembly 40A and a rotating module (not shown) included in the second washing assembly 40B may be driven by a single motor (e.g., the motor 72 of FIG. 3) by a power transmission unit (e.g., the power transmission unit 74 of FIG. 4). The first washing element 441 included in the first washing assembly 40A and the second washing element (not shown) included in the second washing assembly 40B may be formed to branch out from a single spray root 440.

Hereinafter, a method of operating the high-pressure washer 1 according to an embodiment is described as an example with reference to FIGS. 1 to 5. The high-pressure washer 1 may start operating when the cover 20 is closed after the WO is attached to the jig 421 of the rotating module 42. The pump 60 according to an embodiment may pull the washing water stored in the water storage tank 50 and transport the washing water to the washing assembly 40. The washing water transported to the washing assembly 40 may be sprayed onto the WO by the first washing element 441 and the second washing element 442 of the washing module 44. While the washing water is sprayed onto the WO, the WO may be easily washed on all sides by rotating around a single axis by the rotating module 42. The washing water used to wash the WO may fall downward due to gravity and may be returned to the water storage tank 50. The washing water returned to the water storage tank 50 may contain glue residue and other contaminants, and these contaminants may be self-cleaned by being discharged to the outside of the high-pressure washer 1 by the water cleaning module 90. The washing water in the water storage tank 50 may be moved to the filter device 70 by the pump 60, filtered, and then transferred to the washing assembly 40. Through the above series of processes, the high-pressure washer 1 using reusable washing water may operate. The series of operations of the high-pressure washer 1 may be controlled by a user through a touch panel included in the screen 12 according to FIG. 1.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents of the claims are within the scope of the following claims.

1. A high-pressure washer comprising:
a main body;
a cover configured to cover an upper portion of the main body;
a washing tank formed between the main body and the cover;
a washing assembly disposed in the washing tank,
wherein the washing assembly comprises a washing module configured to clean a washing object, and
wherein the washing module comprises a first washing element disposed outside the washing object and configured to spray washing water and a second washing element disposed in the washing object and configured to spray washing water.

2. The high-pressure washer of claim 1, wherein the washing assembly further comprises a rotating module configured to rotate the washing object.

3. The high-pressure washer of claim 2, further comprising:
a jig configured to fix the washing object to the rotating module.

4. The high-pressure washer of claim 1, wherein the first washing element and the second washing element comprise:
a spray stem extending upward in the washing tank and through which washing water moves;
a spray branch extending outward from the spray stem; and
a spray nozzle disposed at an end of the spray branch.

5. The high-pressure washer of claim 4, wherein
the spray branch extends in a direction traversing a longitudinal direction of the spray stem, and
the spray nozzle faces the washing object.

6. The high-pressure washer of claim 1, further comprising:
a water storage tank formed on a bottom of the washing tank,
wherein washing water that washes the washing object is returned to the water storage tank, filtered, and reused.

7. The high-pressure washer of claim 6, wherein
the washing assembly further comprises a rotating module configured to rotate the washing object, and
the rotating module is rotated by a motor disposed to be spaced apart from the washing tank and the water storage tank, and the motor is connected to the rotating module by a power transmission unit.

8. The high-pressure washer of claim 6, further comprising:
a water cleaning module disposed in the water storage tank,
wherein the water cleaning module comprises a suction port formed at a height corresponding to a water surface level of the washing water stored in the water storage tank and a discharge port configured to discharge floating matter introduced into the suction port to outside.

9. The high-pressure washer of claim 8, further comprising:
a circulation port in fluid communication with the water storage tank,
wherein the circulation port is configured to transport the washing water returned to the water storage tank to a filter device.

10. The high-pressure washer of claim 6, further comprising:
a heater disposed in the water storage tank and configured to heat the washing water.

11. The high-pressure washer of claim 1, wherein two or more of the washing assemblies are disposed in the washing tank.

12. The high-pressure washer of claim 2, wherein the second washing element is disposed on a central upper portion of the rotating module.

13. A high-pressure washer comprising:
a main body;
a cover configured to cover the main body;
a washing tank formed between the main body and the cover; and
a washing assembly disposed in the washing tank,
wherein the washing assembly comprises:
a rotating module configured to rotate a washing object; and
a washing module configured to clean the washing object, and
wherein the washing module comprises a first washing element disposed to be spaced apart from the rotating module and a second washing element disposed at a center of the rotating module.

14. The high-pressure washer of claim 13, wherein the first washing element comprises a first nozzle facing an outer portion of the washing object, and the second washing element comprises a second nozzle disposed to face an inner portion of the washing object.
